(19) United States
(12) Patent Application Publication
(10) Pub. No.: US 2026/0131592 A1
(43) Pub. Date: May 14, 2026

(54) WRITING TOOL

(71) Applicant: KABUSHIKI KAISHA PILOT CORPORATION (also trading as PILOT CORPORATION), Tokyo (JP)

(72) Inventors: Kaede YAMADA, Tokyo (JP); Ryosuke KURIYAMA, Tokyo (JP); Hiroshi SAITO, Tokyo (JP)

(73) Assignee: KABUSHIKI KAISHA PILOT CORPORATION (also trading as PILOT CORPORATION), Tokyo (JP)

(21) Appl. No.: 19/121,512

(22) PCT Filed: Oct. 12, 2023
(86) PCT No.: PCT/JP2023/037051

§ 371 Date: Apr. 16, 2025

(30) Foreign Application Priority Data
Oct. 17, 2022 (JP) 2022-166180

(51) Int. Cl. B43K 23/008; B43K 7/00; B43K 25/02

(52) U.S. Cl. CPC B43K 23/008; B43K 25/02; B43K 7/005

(57) ABSTRACT

An axial cylinder extending in an axial direction along a center axis and a writing member disposed inside the axial cylinder. The axial cylinder has fiber-like protrusions protruding toward an outside in a radial direction from an outer circumferential surface of the axial cylinder, the plurality of fiber-like protrusions are provided side by side on the outer circumferential surface, and each of the fiber-like protrusions has a plurality of rib parts which extend in predetermined directions when viewed from the outside in the radial direction and which are disposed side by side in a width direction orthogonal to the predetermined directions and a step part which is disposed between rib parts adjacent to each other in the width direction or disposed at an end portion in the width direction of the rib parts and extends in a predetermined direction.

### TECHNICAL FIELD

The present invention relates to a writing tool.

Priority is claimed on Japanese Patent Application No. 2022-166180, filed Oct. 17, 2022, the content of which is incorporated herein by reference.

### BACKGROUND ART

In the related art, for example, as writing tools such as ballpoint pens, writing tools which include an axial cylinder made of a resin or the like, a writing member such as a replacement lead disposed inside the axial cylinder, and a grip part made of a rubber or the like which fits onto an outer circumferential surface of the axial cylinder are known. A writing tool described in Patent Document 1 has a non-slip concave groove formed in a grip part.

### CITATION LIST

### Patent Document

### Patent Document 1

[Patent Document 1] Japanese Patent No. 4043305

### SUMMARY OF INVENTION

### Technical Problem

There is room for improvement in this type of writing tool, both in terms of design and usability.

Also, it is difficult to provide a visual and tactile sensation as if an outer circumferential surface of an axial cylinder were formed of an actual fabric or the like.

An object of the present invention is to provide a writing tool which can provide a sensation as if an outer circumferential surface of an axial cylinder were formed of a fabric or the like, can have an excellent exterior form to enhance the design, provides an excellent touch sensation, and has the improved usability.

In order to achieve the above object, the present invention provides the following means.

### Aspect 1 of Present Invention

A writing tool includes: an axial cylinder which extends in an axial direction along a center axis; and a writing member which is disposed inside the axial cylinder, in which the axial cylinder has fiber-like protrusions which protrude outward in a radial direction from an outer circumferential surface of the axial cylinder, the plurality of fiber-like protrusions are provided side by side on the outer circumferential surface, and each of the fiber-like protrusions has a plurality of rib parts which extend in a predetermined direction when viewed from an outside in the radial direction and are disposed side by side in a width direction which is orthogonal to the predetermined direction, and step parts which are disposed between the rib parts adjacent to each other in the width direction or at end portions in the width direction of the rib parts and extend in the predetermined direction.

In the writing tool according to the present invention, the plurality of fiber-like protrusions are provided on the outer circumferential surface of the axial cylinder. Each of the fiber-like protrusions has the plurality of rib parts which extend in the predetermined direction and the step parts which are disposed between the rib parts adjacent to each other in the width direction or at an end portions in the width direction of the rib parts. The plurality of fiber-like protrusions configured in this way can provide, to a user or the like, a sensation as if the outer circumferential surface of the axial cylinder were formed of an actual fabric or cloth woven with thread or a tatami mat or the like woven with rush or the like (hereinafter referred to as a fabric or the like).

Specifically, the plurality of rib parts and the step parts allow the shading of the fiber-like protrusions to approximate the shading of threads, rushes, or the like that are an element of a fabric or the like. For this reason, it is possible to provide, to a user or the like of the writing tool, a visual sensation as if the outer circumferential surface of the axial cylinder were formed of a fabric or the like.

Also, when a user or the like of the writing tool touches the fiber-like protrusions with his or her fingertips or the like, the plurality of rib parts and the step part can provide a tactile sensation as if the user were touching the surface of an actual fabric. Specifically, it is possible to obtain a sensation having directionality, for example, as if the fiber of the surface of a thread, a rush, or the like extended in the predetermined direction.

Also, when the writing tool is used, the outer circumferential surface of the axial cylinder comes into contact with the “inter-finger space” between the base of the index finger and the base of the thumb of the user's hand. In the writing tool, the fiber-like protrusions are provided so that the tactile feel of the axial cylinder between the fingers can also be made pleasant.

As described above, according to the present invention, it is possible to provide a writing tool which can provide a sensation as if an outer circumferential surface of an axial cylinder were formed of an actual fabric or the like, can have an excellent exterior form to enhance the design, provides an excellent touch sensation, and has the improved usability.

### Aspect 2 of Present Invention

In the writing tool according to aspect 1, the fiber-like protrusion has a larger amount of protrusion toward the outside in the radial direction in an intermediate portion located between both the end portions in the predetermined direction than in both the end portions.

### Aspect 3 of Present Invention

In the writing tool according to aspect 1 or 2, the fiber-like protrusion has a larger amount of protrusion toward the outside in the radial direction in an intermediate portion located between both the end portions in the width direction than in both the end portions.

In this case, the shape of the fiber-like protrusions can be provided to more closely resemble the shape of the exposed parts of threads, rushes, or the like which constitute an actual fabric or the like. This makes it possible to more stably impart visual and tactile sensations as if the outer circumferential surface of the axial cylinder were formed of an actual fabric or the like. The effects of improving the design and the usability become more pronounced.

### Aspect 4 of Present Invention

In the writing tool according to any one of aspects 1 to 3, the plurality of rib parts each include outer rib parts which are disposed at outer end portions in the width direction of the fiber-like protrusions, and inner rib parts which are disposed further inward in the width direction than the outer rib parts, and the inner rib parts each have a portion having a larger amount of protrusions toward the outside in the radial direction than the outer rib parts.

In this case, the fiber-like protrusions have the inner rib part located on the inside in the width direction protruding further toward the outside in the radial direction than the outer rib part located on the outer end portion in the width direction. Thus, the shape of the fiber-like protrusions can be provided to more closely resemble the shape of exposed parts of threads, rushes, or the like which constitute an actual fabric or the like. Therefore, the above-described effects become more pronounced.

### Aspect 5 of Present Invention

In the writing tool according to aspect 4, the plurality of inner rib parts are provided side by side in the width direction.

### Aspect 6 of Present Invention

In the writing tool according to aspect 5, the plurality of inner rib parts are different from each other in an amount of protrusions toward the outside in the radial direction.

In this case, the fiber-like protrusions have a plurality of inner rib parts aligned in the width direction and the amounts of protrusions (that is, height dimension) toward the outside in the radial direction of the inner rib parts are different from each other.

Thus, the shape of the fiber-like protrusions can be provided to more closely resemble the shape of exposed parts of threads, rushes, or the like which constitute an actual fabric or the like. Therefore, the above-described effects become more pronounced.

### Aspect 7 of Present Invention

In the writing tool according to aspect 5 or 6, the plurality of inner rib parts each include, of the plurality of inner rib parts, first inner rib parts which have a largest amount of protrusions toward the outside in the radial direction in a center portion in the predetermined direction, and second inner rib parts which have a smaller amount of protrusions toward the outside in the radial direction in the center portion in the predetermined direction than the first inner rib parts, and an amount of protrusions toward the outside in the radial direction at the end portions in the predetermined direction of the second inner rib parts is greater than an amount of protrusions toward the outside in the radial direction at the end portions in the predetermined direction of the first inner rib parts.

In this case, of the plurality of inner rib parts included in the fiber-like protrusions, the inclination and the shape of the first inner rib part and the second inner rib part are different from each other. Thus, the shape of the fiber-like protrusions can be provided to more closely resemble the shape of exposed parts of threads, rushes, or the like which constitute an actual fabric or the like. Therefore, the above-described effects become more pronounced.

### Aspect 8 of Present Invention

In the writing tool according to any one of aspects 1 to 7, the plurality of fiber-like protrusions each include an axial protrusion which extends in an axial direction, and a circumferential protrusion which extends in a circumferential direction, and the axial protrusion and the circumferential protrusion are arranged alternately in at least one of the axial direction and the circumferential direction.

In this case, for example, the axial protrusions act (function) as warp threads and the circumferential protrusions act (function) as weft threads. In addition, it is possible to impart a visual and tactile sensation to the axial cylinder as if they were alternately interwoven with each other. This more effectively imparts the sensation as if the outer circumferential surface of the axial cylinder were formed of an actual fabric or the like.

### Aspect 9 of Present Invention

In the writing tool according to any one of aspects 1 to 8, the plurality of fiber-like protrusions each include an axial protrusion which extends in an axial direction, and a circumferential protrusion which extends in a circumferential direction, and the axial protrusion has a larger amount of protrusions toward the outside in the radial direction than the circumferential protrusion.

In this case, for example, the axial protrusions act (function) as warp threads and the circumferential protrusions act (function) as weft threads. Since the amount of protrusions of the axial protrusions is greater than the amount of protrusions of the circumferential protrusions, the warp threads (axial protrusions) can be more visually and tactilely emphasized than the weft threads (circumferential protrusions) on the outer circumferential surface of the axial cylinder. For this reason, it is possible to further increase the degree of freedom in design and further improve a touch sensation.

### Aspect 10 of Present Invention

In the writing tool according to any one of aspects 1 to 9, the plurality of fiber-like protrusions each include a plurality of types of axial protrusions which extend in an axial direction and have different shapes, and a plurality of types of circumferential protrusions which extend in a circumferential direction and have different shapes.

In this case, for example, the axial protrusions act (function) as warp threads and the circumferential protrusions act (function) as weft threads. If the plurality of types of axial protrusions are provided and the plurality of types of circumferential protrusions are provided, it is possible to more effectively impart a visual and tactile sensation as if the outer circumferential surface of the axial cylinder were formed of an actual fabric or the like.

### Aspect 11 of Present Invention

In the writing tool according to any one of aspects 1 to 10, the fiber-like protrusions have textured surfaces on surfaces thereof.

In this case, since the surfaces of the fiber-like protrusions have a textured surface, it is possible to impart a subtle matte shading and a smooth and comfortable feel to the fiber-like protrusions. For this reason, it is possible to further improve the design and to further improve the usability.

### Aspect 12 of Present Invention

In the writing tool according to any one of aspects 1 to 11, the axial cylinder has a parting line which is disposed on an outer circumferential surface of the axial cylinder and extends in an axial direction, the plurality of fiber-like protrusions include a plurality of circumferential protrusions which extend in a circumferential direction, and at least one of the plurality of circumferential protrusions is located on the parting line.

For example, when the axial cylinder made of a resin is subjected to injection molding between a pair of molds, the parting line is disposed to extend in the axial direction on the outer circumferential surface of the axial cylinder along the opposing surfaces (parting surfaces) of the pair of molds. Unlike the above constitution, for example, in the case where the fiber-like protrusions (axial protrusions) extending in the axial direction are arranged on the parting line, when a pair of molds are separated from each other after injection molding, the axial protrusions on the parting line may rub against the molds, causing them to break off or become burrs.

On the other hand, as in the above constitution, when the circumferential protrusions extending in the circumferential direction are located on the parting line, a pair of molds are spaced apart from each other in a direction in which the circumferential protrusions extend. Thus, this makes it possible to suppress defects such as chipping and burrs as described above. For this reason, while the parting line necessary for manufacturing is provided on the outer circumferential surface of the axial cylinder, it is possible to prevent the pattern of a fabric or the like from being interrupted or looking unnatural on the parting line, thereby making it possible to further improve the design.

### Aspect 13 of Present Invention

In the writing tool according to aspect 12, the parting line has a textured surface which extends in an axial direction.

In this case, while the parting line necessary for manufacturing can be provided on the outer circumferential surface of the axial cylinder, the parting line can be made inconspicuous. For this reason, it becomes possible to further improve the design.

### Aspect 14 of Present Invention

The writing tool according to any one of aspects 1 to 13 further includes: a clip which is disposed to face the axial cylinder from the outside in the radial direction and extends in an axial direction, in which the plurality of fiber-like protrusions include an axial protrusion in which the axial protrusion and the clip overlap when viewed from a radial direction and which extends in an axial direction.

In this case, when the clip is used to hang the writing tool on a pocket or the like of a user's clothing or the like and be held or when the writing tool is removed from a pocket or the like, the material of the pocket or the like is made to slide easily between the clip and the axial protrusions and the material is stably clamped. The writing tool is easily hung on a pocket or the like and is also easily removed, making it comfortable to use.

### Aspect 15 of Present Invention

The writing tool according to any one of aspects 1 to 14 further includes: a grip part which fits onto an outer circumferential surface of the axial cylinder, in which the fiber-like protrusions are disposed on a portion of the outer circumferential surface of the axial cylinder other than a portion covered by the grip part.

In this case, the grip part provides an anti-slip function during writing or the like and the fiber-like protrusions are not blocked by the grip part. For this reason, the above-described effects can be obtained more stably.

### Advantageous Effects of Invention

According to a writing tool of the above aspect of the present invention, it is possible to provide a writing tool which can provide a sensation as if an outer circumferential surface of an axial cylinder were formed of a fabric or the like, can have an excellent exterior form to enhance the design, provides an excellent touch sensation, and has the improved usability.

### BRIEF DESCRIPTION OF DRAWINGS

FIG. 1 A side view showing a writing tool according to first and second embodiments, in which the illustration of fiber-like protrusions disposed on an outer circumferential surface of an axial cylinder, a parting line, and the like is omitted.

FIG. 2 A plan view showing the outer circumferential surface of the axial cylinder of the writing tool of the first embodiment in a developed form and an enlarged view showing a part of the plan view in an enlarged form.

FIG. 3 An enlarged view of portion III in FIG. 2, specifically, a plan view showing a first axial protrusion of a plurality of fiber-like protrusions.

FIG. 4 An enlarged view of portion IV in FIG. 2, specifically, a plan view showing a second axial protrusion of the plurality of fiber-like protrusions.

FIG. 5 An enlarged view of portion V in FIG. 2, specifically, a plan view showing a first circumferential protrusion of the plurality of fiber-like protrusions.

FIG. 6 An enlarged view of portion VI in FIG. 2, specifically, a plan view showing a second circumferential protrusion of the plurality of fiber-like protrusions.

FIG. 7 A perspective view showing an example of fiber-like protrusions, specifically, the first axial protrusion in FIG. 3.

FIG. 8 A cross-sectional view showing a cross section taken along line VIII-VIII in FIG. 3.

FIG. 9 A cross-sectional view showing a cross section taken along line IX-IX in FIG. 3.

FIG. 10 A cross-sectional view showing a cross section taken along line X-X in FIG. 3.

FIG. 11 A cross-sectional view showing a cross section taken along line XI-XI in FIG. 3.

FIG. 12 A cross-sectional view showing a cross section taken along line XII-XII in FIG. 3.

FIG. 13 A cross-sectional view showing a cross section taken along line XIII-XIII in FIG. 3.

FIG. 14 A cross-sectional view showing a cross section taken along line XIV-XIV in FIG. 4. FIG. 15 A cross-sectional view showing a cross section taken along line XV-XV in FIG. 4.

FIG. 16 A cross-sectional view showing a cross section taken along line XVI-XVI in FIG. 4.

FIG. 17 A cross-sectional view showing a cross section taken along line XVII-XVII in FIG. 4.

FIG. 18 A cross-sectional view showing a cross section taken along line XVIII-XVIII in FIG. 4.

FIG. 19 A cross-sectional view showing a cross section taken along line XIX-XIX in FIG. 4.

FIG. 20 A cross-sectional view showing a cross section taken along line X in FIG. 5.

FIG. 21 A cross-sectional view showing a cross section taken along line XXI-XXI in FIG. 5.

FIG. 22 A cross-sectional view showing a cross section taken along line XXII-XXII in FIG. 5.

FIG. 23 A cross-sectional view showing a cross section taken along line XXIII-XXIII in FIG. 5.

FIG. 24 A cross-sectional view showing a cross section taken along line XXIV-XXIV in FIG. 5.

FIG. 25 A cross-sectional view showing a cross section taken along line XXV-XXV in FIG. 6.

FIG. 26 A cross-sectional view showing a cross section taken along line XXVI-XXVI in FIG. 6.

FIG. 27 A cross-sectional view showing a cross section taken along line XXVII-XXVII in FIG. 6.

FIG. 28 A cross-sectional view showing a cross section taken along line XXVIII-XXVIII in FIG. 6.

FIG. 29 A cross-sectional view showing a cross section taken along line XXIX-XXIX in FIG. 6.

FIG. 30 A plan view showing an outer circumferential surface of an axial cylinder of a writing tool according to a modified example of the first embodiment in a developed form and an enlarged view showing a part of the plan view in an enlarged form.

FIG. 31 A plan view showing an outer circumferential surface of an axial cylinder of a writing tool according to a second embodiment in a developed form and an enlarged view showing a part of the plan view in an enlarged form.

FIG. 32 An enlarged view of portion XXXII of FIG. 31, specifically, a plan view showing fiber-like protrusions (axial protrusions).

FIG. 33 A cross-sectional view showing a cross section taken along line XXXIII-XXXIII in FIG. 32.

FIG. 34 A cross-sectional view showing a cross section taken along line XXXIV-XXXIV in FIG. 32.

FIG. 35 A cross-sectional view showing a cross section taken along line XXXV-XXXV in FIG. 32.

FIG. 36 A cross-sectional view showing a cross section taken along line XXXVI-XXXVI in FIG. 32.

FIG. 37 A cross-sectional view showing a cross section taken along line XXXVII-XXXVII in FIG. 32.

### DESCRIPTION OF EMBODIMENTS

### First Embodiment

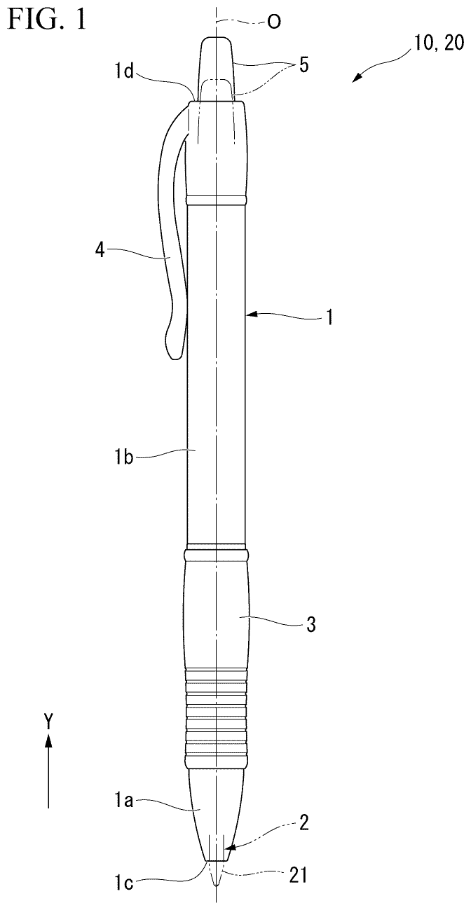

A writing tool 10 in a first embodiment of the present invention will be described with reference to FIGS. 1 to 29. The writing tool 10 in the embodiment is, for example, a ballpoint pen or the like, specifically, a knock-type ballpoint pen or the like.

As shown in FIG. 1, the writing tool 10 has a generally cylindrical shape with a center axis O as a center thereof. The writing tool 10 includes an axial cylinder 1 extending along the center axis O, a writing member 2 disposed inside the axial cylinder 1, a grip part 3 fitting onto an outer circumferential surface of the axial cylinder 1, a clip 4, a biasing member (not shown), a knock mechanism (not shown), and a push-in part 5. The axial cylinder 1, the writing member 2, the grip part 3, the biasing member, the knock mechanism, and the push-in part 5 are disposed coaxially with each other to have the center axis O as a common axis.

The definition of directions used in the embodiment will be explained.

In the embodiment, a direction in which the center axis O of the writing tool 10 extends, that is, a direction along the center axis O, is called an axial direction. In the axial direction, a tip 21 constituting a pen tip of the writing member 2 and the push-in part 5 are disposed at different positions from each other. In the axial direction, a direction which is directed from the push-in part 5 toward the tip 21 is called a front side and a direction which is directed from the tip 21 toward the push-in part 5 is called a rear side. For this reason, the axial direction may also be rephrased as a forward/rearward direction. In each drawing, the axial direction (forward/rearward direction) corresponds to a Y axial direction. The front side corresponds to a −Y side and the rear side corresponds to a +Y side.

A direction orthogonal to the center axis O is referred to as a radial direction. In the radial direction, a direction of approach to the central axis O is referred to as inward in a radial direction and a direction away from the central axis O is referred to as outward in the radial direction. In each drawing, the radial direction corresponds to a Z axial direction, the inside in the radial direction corresponds to a −Z side, and the outside in the radial direction corresponds to a +Z side.

A direction going around the central axis O is referred to as a circumferential direction. In each drawing, the circumferential direction corresponds to an X-axis direction. In this embodiment, when the writing tool 10 is viewed from the rear side (+Y side), one side in the circumferential direction which is in a counterclockwise direction around the central axis O as a center thereof corresponds to a +X side and the other side in the circumferential direction which is in a clockwise direction around the central axis O as a center thereof corresponds to a −X side.

Each constituent element of the writing tool 10 will be explained.

As shown in FIG. 1, the axial cylinder 1 has a cylindrical shape in which it has the center axis O as a center thereof and extends in the axial direction. The axial cylinder 1 is made of a resin whose main component is, for example, polycarbonate or the like. The axial cylinder 1 is formed by assembling a plurality of cylindrical members by, for example, screwing, fitting, or bonding them together. Although not particularly shown, each constituent member of the axial cylinder 1 is formed through so-called injection molding in which a molten resin material is injected between a pair of molds and a core and then solidified.

The axial cylinder 1 has a portion made of, for example, a colorless transparent material. Furthermore, the axial cylinder 1 may have a portion made of an opaque material having, for example, black or the like. That is to say, the axial cylinder 1 includes at least one of a transparent member and an opaque member. The transparent member may be a transparent member imparted with a predetermined color. In the embodiment, the term “transparent” is a concept that it includes the term “semi-transparent.” More specifically, when the writing tool 10 is viewed from the outside in the radial direction, the writing member 2 accommodated inside the axial cylinder 1 can be seen visually through the axial cylinder 1, which is referred to as “transparent.” Furthermore, the opaque member may be an opaque member imparted with a predetermined color other than black.

The axial cylinder 1 has a front shaft 1a and a rear shaft 1b disposed on a rear side of the front shaft 1a. The front shaft 1a and the rear shaft 1b each have a cylindrical shape and are disposed side by side in the axial direction. A rear end portion of the front shaft 1a and a front end portion of the rear shaft 1b are fixed to each other in an attachable and detachable manner through screwing or the like.

A front end portion of the front shaft 1a has a tapered cylinder shape in which a diameter thereof narrows toward the front side. The front end portion of the front shaft 1a may also be rephrased as a tapered cylindrical part. The front shaft 1a has a front-end opening portion 1c which is disposed in a tapered cylindrical part and is opened to the front side. The rear shaft 1b has a rear-end opening portion 1d which is disposed at a rear end portion of the rear shaft 1b and is opened to the rear side.

Also, the front shaft 1a has a male thread portion (not shown) disposed at a rear end portion in the axial direction of the front shaft 1a. The male thread portion protrudes further to the rear side than the grip part 3 which will be described below. The rear shaft 1b has a female thread portion (not shown) disposed at a front end portion in the axial direction of the rear shaft 1b. The female thread portion is screwed into the male thread portion of the front shaft 1a.

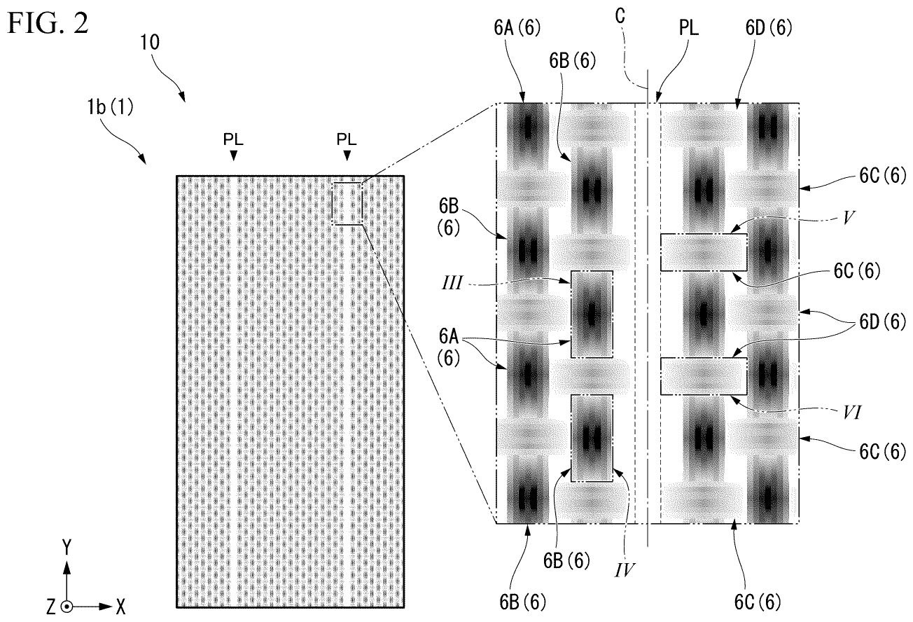

FIG. 2 is a plan view showing an outer circumferential surface of the rear shaft 1b (the axial cylinder 1) in a developed form and an enlarged view showing a part of the plan view in an enlarged form. As shown in FIG. 2, the rear shaft 1b, that is, the axial cylinder 1, has fiber-like protrusions 6 and parting lines PL disposed on the outer circumferential surface of the axial cylinder 1. Specifically, the fiber-like protrusions 6 and the parting lines PL are disposed on at least a part of the outer circumferential surface of the rear shaft 1b. In FIG. 1, the illustration of the fiber-like protrusions 6 and the parting lines PL is omitted. The detailed configurations of the fiber-like protrusions 6 and the parting lines PL will be described separately later.

The writing member 2 may also be rephrased as a replacement lead, a refill, or the like. In FIG. 1, the writing member 2 is attached to the inside of the axial cylinder 1 in an attachable and detachable manner. The writing member 2 can be removed from the inside of the axial cylinder 1 and replaced by disassembling the axial cylinder 1 into a plurality of parts (the front shaft la and the rear shaft 1b in the embodiment).

As shown in FIG. 1, the writing member 2 has the tip 21 and an ink storage tube (not shown) connected to a rear end portion of the tip 21. The tip 21 has a ball disposed at a front end portion of the tip 21 and a holder which holds the ball.

In the embodiment, the writing tool 10 is a knock-type ballpoint pen. For this reason, the writing member 2 is movable in the axial direction between a usage position in which the tip 21 protrudes from the front-end opening portion 1c of the axial cylinder 1 to the front side and an accommodation position in which the entire writing member 2 including the tip 21 is accommodated in the axial cylinder 1.

Although not particularly shown, the ink storage tube is disposed inside the axial cylinder 1. The ink storage tube has a cylindrical shape in which it has the center axis O as a center thereof and extends in the axial direction. For example, an ink such as gel ink and grease which is placed at the rear side of the ink and prevents the ink from evaporating or flowing back (flowing to the rear side) are accommodated inside the ink storage tube. The ink storage tube may also be rephrased as a cartridge or the like.

The grip part 3 is made of, for example, an elastic material which is elastically deformable such as elastomer or rubber. Here, the present invention is not limited thereto and the grip part 3 may be formed of a resin member other than the elastic material. The grip part 3 has a cylindrical shape in which it has the center axis O as a center thereof and extends in the axial direction. The grip part 3 fits onto the outer circumferential surface of the front shaft 1a. Specifically, the grip part 3 fits onto a portion of the outer circumferential surface of the front shaft la which is located between the front end portion (tapered cylindrical part) and the rear end portion (male thread portion) in the axial direction.

The clip 4 is connected to the rear end portion in the axial direction of the axial cylinder 1 and further protrudes in the outside in the radial direction than the outer circumferential surface of the axial cylinder 1. Specifically, the clip 4 is connected to the rear end portion of the outer circumferential surface of the rear shaft 1b and extends in the axial direction from the connection portion toward the front side. The clip 4 is disposed to face the rear shaft 1b, that is, the outer circumferential surface of the axial cylinder 1, from the outside in the radial direction. A part of the clip 4 may be in contact with the outer circumferential surface of the axial cylinder 1. The clip 4 may be integrally formed with one of a plurality of constituent members included in the rear shaft 1b as a single member. The clip 4 is made of an elastically deformable resin or metal or the like.

By using the clip 4, a user can hang the writing tool 10 on a pocket or the like of clothing or the like and be held. Furthermore, the provision of the clip 4 prevents the writing tool 10 from unintentionally rolling on a desk or the like.

Although not particularly shown, the biasing member is, for example, a compression coil spring or the like. The biasing member has a spiral shape in which it has the center axis O as a center thereof. The biasing member is disposed inside the axial cylinder 1 and biases the writing member 2 toward the rear side. In the embodiment, the biasing member is accommodated inside the front shaft 1a.

The push-in part 5 has a cylindrical shape in which it has the center axis O as a center thereof and extends in the axial direction. The push-in part 5 has, for example, a top-shaped cylindrical shape or the like with a closed rear end portion. The push-in part 5 is inserted into the rear-end opening portion 1d of the axial cylinder 1. At least a part (the rear end portion) of the push-in part 5 protrudes from the rear-end opening portion 1d to the rear side.

Although not particularly shown, the knock mechanism is provided inside the axial cylinder 1. The knock mechanism is configured so that the writing member 2 can be switched between the above-described usage position and accommodation position when the user pushes the push-in part 5 toward the front side against a biasing force of the biasing member and then performs an operation (knock operation) of releasing this pushing. Specifically, each time the user performs a knock operation once, the writing member 2 moves in the axial direction alternately between the usage position and the accommodation position. As the knock mechanism in the embodiment, a structure of the knock mechanism including, for example, a rotating cam or the like which is included in a knock-type ballpoint pen in the related art can be adopted.

The fiber-like protrusions 6 and the parting lines PL will be described in detail below with reference to FIGS. 2 to 29.

As shown in FIG. 2, the fiber-like protrusions 6 and the parting lines PL are disposed on the outer circumferential surface of the rear shaft 1b of the axial cylinder 1. The rear shaft 1b may be made of a transparent material or may be made of an opaque material.

Although not particularly shown, the fiber-like protrusions 6 and the parting lines PL may also be disposed on the outer circumferential surface of the front shaft 1a of the axial cylinder 1. Here, in this case, the fiber-like protrusions 6 and the parting lines PL are disposed on a portion (for example, a tapered cylindrical part or the like) of the outer circumferential surface of the front shaft la other than a portion onto which the grip part 3 fits.

That is to say, the fiber-like protrusions 6 and the parting lines PL are arranged on a portion of the outer circumferential surface of the axial cylinder 1 other than a portion covered by the grip part 3.

In the embodiment, the fiber-like protrusions 6 and the parting lines PL are formed on the outer circumferential surface of the rear shaft 1b by transferring the shape of the inner surfaces of a pair of molds (not shown) used at the time of injection-molding the rear shaft 1b. Specifically, the inner surfaces of a pair of molds for injection-molding the rear shaft 1b are subjected to precise concave engraving (laser engraving) (not shown) through laser processing. This laser engraved concave shape is transferred as a convex shape (a shape that is an inverse of the concave shape) to the outer circumferential surface of the rear shaft 1b during injection molding. Thus, precise convex fiber-like protrusions 6 are formed on the outer circumferential surface of the axial cylinder 1.

For this reason, the fiber-like protrusions 6 are provided to protrude in the outside in the radial direction from the outer circumferential surface of the axial cylinder 1. Specifically, the “outer circumferential surface” refers to a portion of the outer circumferential surface of the axial cylinder 1 other than a portion where the fiber-like protrusions 6 and the parting lines PL are disposed. In the embodiment, this portion may be referred to as a base surface, a reference surface, or the like to distinguish it from the fiber-like protrusions 6 and the parting lines PL in some cases. The base surface (reference surface) is disposed, for example, between adjacent fiber-like protrusions 6 or between a fiber-like protrusion 6 and the parting lines PL which are adjacent to each other.

The base surface is formed by transferring the shape of the portions of the inner surfaces of a pair of molds used for injection-molding the rear shaft 1b which have not been subjected to laser processing, that is, a non-laser processed portions, to the outer circumferential surface of the rear shaft 1b during injection molding. The base surface formed on the outer circumferential surface of the rear shaft 1b has a shiny glossy surface because the non-laser processed portion is transferred onto the base surface.

The monochrome images shown in each drawing of FIGS. 2 to 6 show the laser intensity (laser output) when subjecting the inner surface of the mold for forming the rear shaft 1b to laser processing using shades of black and white. As shown in the monochrome images in each drawing, the laser intensity of the laser processed portions on the inner surface of the mold is changed in stages or gradually (in a gradational form), and thus the inner surface of the mold is subjected to precise laser engraving (precision engraving).

The shape of the laser processed portion of the inner surface of the mold is inverted and transferred as is to the outer circumferential surface of the rear shaft 1b. For this reason, it can be said that the monochrome images shown in drawings of FIGS. 2 to 6 show amounts of protrusions in which the fiber-like protrusions 6 protrude in the outside in the radial direction from the outer circumferential surface (base surface) of the rear shaft 1b using shades of black and white. That is to say, the amounts of protrusions in the fiber-like protrusions 6 are changed in stages or gradually (in a gradational form) in each part of the fiber-like protrusions 6.

More specifically, in the monochrome image shown in each drawing, the amount of protrusions of the fiber-like protrusions 6 increases as the shades of black and white increase (a portion which is closer to 100% black). Furthermore, as the shades of black and white decrease (a portion which is closer to 100% white, in other words, a portion which is closer to 0% black), the amount of protrusions of the fiber-like protrusions 6 decreases.

A maximum value (maximum protrusion dimension) of the amount of protrusions which is an amount of protrusions in which the fiber-like protrusions 6 protrude in the outside in the radial direction from the outer circumferential surface (base surface) of the axial cylinder 1, is, for example, 100 μm or less. In the embodiment, the maximum protrusion dimension of the fiber-like protrusions 6 is, for example, about 50 μm. More specifically, in the fiber-like protrusions 6 shown in the monochrome image of FIG. 2, the amount of protrusions in the darkest portion (100% black) corresponds to about 50 μm (maximum amount of protrusions) and the amount of protrusions in the lightest portion (0% black) corresponds to about 0 μm.

As shown in FIG. 2, the plurality of fiber-like protrusions 6 are provided side by side on the outer circumferential surface of the rear shaft 1b (the axial cylinder 1). The plurality of fiber-like protrusions 6 include axial protrusions 6A and 6B extending in the axial direction (Y-axis direction) and circumferential protrusions 6C and 6D extending in the circumferential direction (X-axis direction).

The plurality of axial protrusions 6A and 6B are provided. The plurality of axial protrusions 6A and 6B include a first axial protrusion 6A and a second axial protrusion 6B having a shape different from that of the first axial protrusion 6A.

Furthermore, the plurality of circumferential protrusions 6C and 6D are provided. The plurality of circumferential protrusions 6C and 6D include a first circumferential protrusion 6C and a second circumferential protrusion 6D having a shape different from that of the first circumferential protrusion 6C.

That is to say, the plurality of fiber-like protrusions 6 include the plurality of types of axial protrusions 6A and 6B which extend in the axial direction and have mutually different shapes and the plurality of types of circumferential protrusions 6C and 6D which extend in the circumferential direction and have mutually different shapes.

The first axial protrusion 6A and the second axial protrusion 6B are disposed side by side alternately in the axial direction. The rows of the axial protrusions 6A and 6B arranged in the axial direction are provided in a plurality of rows side by side in the circumferential direction. Of a pair of rows of axial protrusions 6A and 6B adjacent to each other in the circumferential direction, the positions in the axial directions of the axial protrusions 6A and 6B in one row and the axial protrusions 6A and 6B in the other row are shifted from each other.

Although not particularly shown, of the rows of the plurality of axial protrusions 6A and 6B arranged side by side in the circumferential direction, at least one row of axial protrusions 6A and 6B are disposed so that they and the clip 4 overlap when viewed in the radial direction. That is to say, the plurality of fiber-like protrusions 6 include axial protrusions 6A and 6B in which they and the clip 4 overlap when viewed in the radial direction and which extend in the axial direction.

The first circumferential protrusion 6C and the second circumferential protrusion 6D are disposed side by side alternately in the axial direction. The rows of the plurality of circumferential protrusions 6C and 6D arranged in the axial direction are provided side by side in the circumferential direction. Of the rows of the pair of circumferential protrusions 6C and 6D adjacent to each other in the circumferential direction, the positions in the axial direction of the circumferential protrusions 6C and 6D in one row and the circumferential protrusions 6C and 6D in the other row are shifted from each other.

Also, the axial protrusions 6A and 6B and the circumferential protrusions 6C and 6D are arranged alternately in at least one of the axial direction and the circumferential direction. In the embodiment, the axial protrusions 6A and 6B and the circumferential protrusions 6C and 6D are arranged alternately in the axial direction and are also arranged alternately in the circumferential direction.

As shown as shades of black and white in the monochrome image in FIG. 2, in the embodiment, the amount of protrusions toward the outside in the radial direction (+Z side) of axial protrusions 6A and 6B is greater than the amount of protrusions toward the outside in the radial direction of circumferential protrusions 6C and 6D. That is to say, compared to the pattern in the circumferential direction imagined using the circumferential protrusions 6C and 6D, the pattern in the axial direction imagined using the axial protrusions 6A and 6B is considered to be a more emphasized design.

Here, a detailed configuration or the like common to each of the fiber-like protrusions 6 (6A to 6D) will be explained.

The fiber-like protrusions 6 have textured surfaces on surfaces thereof. The textured surfaces are frosted-glass-shaped (cloudy-glass-shaped) or satin-finished surfaces which have surface roughness of a predetermined value or more. The textured surface may also be rephrased as, for example, a matte (frosted) processed surface or the like. In the embodiment, the textured surfaces are formed over the entire surfaces of the fiber-like protrusions 6.

Specifically, by subjecting the inner surface of the mold used for forming the rear shaft 1b to laser processing, the surface of the laser processed portion of the inner surface of the mold is roughened to a surface roughness of a predetermined value or more in a microscopic point of view which is finer than the design of the laser engraving. When the rear shaft 1b is subjected to injection molding, the laser processed portion of the inner surface of the mold is transferred to form the fiber-like protrusions 6. Thus, the surfaces of the fiber-like protrusions 6 are roughened to a surface roughness of a predetermined value or more in a microscopic point of view, and thus have textured surfaces.

The fiber-like protrusions 6 extend in a predetermined direction when the outer circumferential surface of the axial cylinder 1 is viewed from the front (that is, when viewed from the outside in the radial direction). That is to say, when viewed from the outside in the radial direction, the dimension in a predetermined direction of the fiber-like protrusions 6 is greater than the dimension thereof in the width direction perpendicular to the predetermined direction. For this reason, in each of the fiber-like protrusions 6 (6A to 6D), the predetermined direction may be referred to as a longitudinal direction and the width direction may be referred to as a transverse direction.

Specifically, of the plurality of types of fiber-like protrusions 6A to 6D, in the axial protrusions 6A and 6B, the predetermined direction corresponds to the Y-axis direction (axial direction) and the width direction corresponds to the X-axis direction (circumferential direction). Furthermore, in the circumferential protrusions 6C and 6D, the predetermined direction corresponds to the X-axis direction (circumferential direction) and the width direction corresponds to the Y-axis direction (axial direction).

Also, a dimension in a predetermined direction of the fiber-like protrusions 6 has, for example, 2 mm or less. In the embodiment, the dimension in the predetermined direction of the fiber-like protrusions 6 is 1.5 mm or less, specifically, about 1.1 to 1.2 mm.

A dimension in the width direction of the fiber-like protrusions 6 has, for example, 1.5 mm or less. In the embodiment, the dimension in the width direction of the fiber-like protrusions 6 is 1 mm or less, specifically, about 0.5 to 0.6 mm.

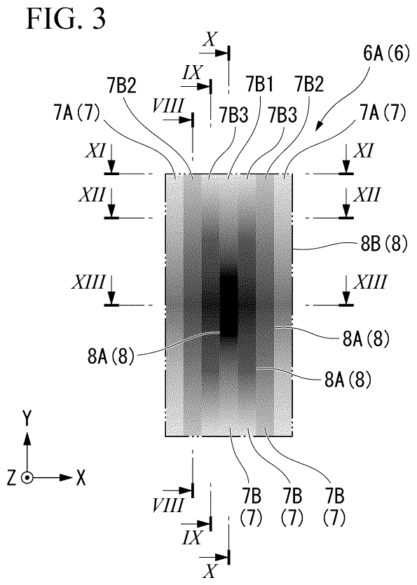

As shown in FIGS. 3 to 6, in the embodiment, the fiber-like protrusions 6 (6A to 6D) are located at a center in a predetermined direction (longitudinal direction) of the fiber-like protrusions 6 and have a shape which is plane-symmetrical with respect to a virtual plane (symmetry plane) (not shown) which extends in a direction (planar direction) perpendicular to the predetermined direction.

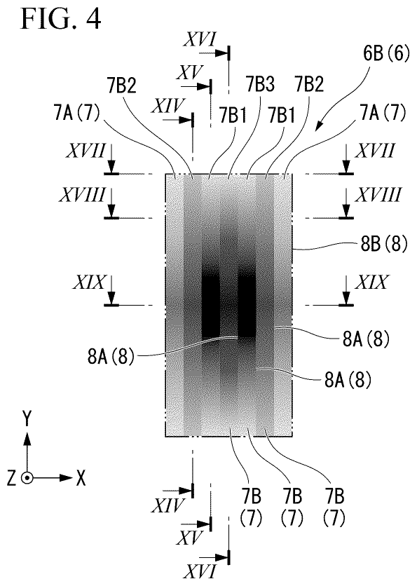

Also, the axial protrusions 6A and 6B shown in FIGS. 3 and 4 are located at the center of the width direction (transverse direction) of the fiber-like protrusions 6 and have a shape which is plane-symmetrical with respect to a virtual plane (symmetry plane) (not shown) which extends in a direction (planar direction) perpendicular to the width direction.

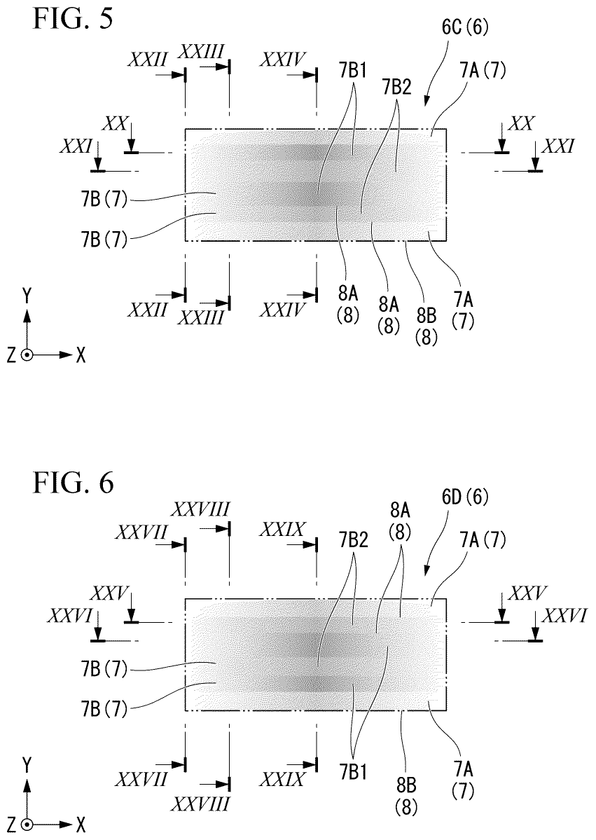

Moreover, the circumferential protrusions 6C and 6D shown in FIGS. 5 and 6 are located at a center in the width direction (transverse direction) of the fiber-like protrusions 6 and have a shape which is plane-asymmetrical with respect to a virtual plane (not shown) which extends in a direction (planar direction) perpendicular to the width direction.

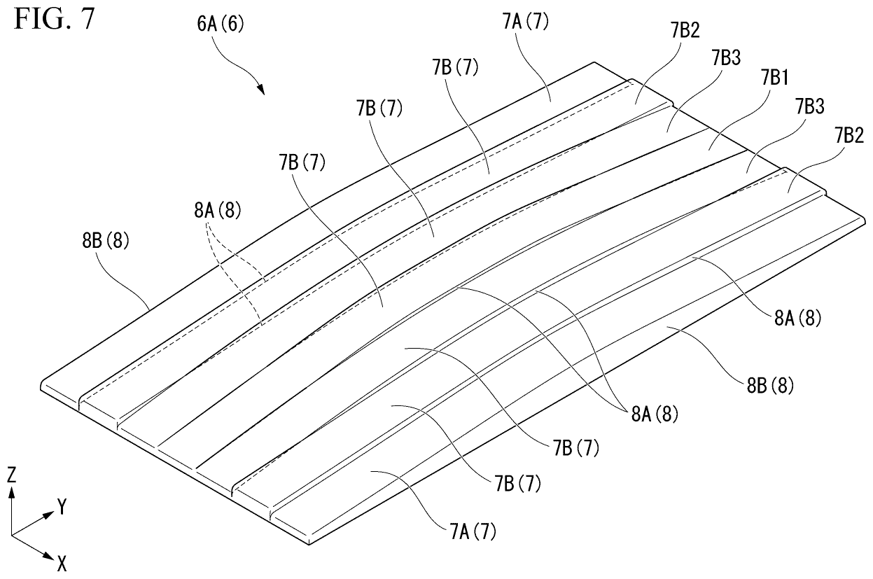

As shown using the shading of the monochrome image in each drawing of FIGS. 3 to 6, each of the fiber-like protrusions 6 (6A to 6D) has a different amount of protrusions toward the outside in the radial direction (+Z side) at each position in a predetermined direction (longitudinal direction). In each of the fiber-like protrusions 6 (6A to 6D), the amount of protrusions toward the outside in the radial direction in an intermediate portion located between both end portions in the predetermined direction is provided larger than the amount of protrusions toward the outside in the radial direction in both end portions of the predetermined direction. The above configuration can be more intuitively understood by referring to FIG. 7 which shows a schematic perspective view of the fiber-like protrusions 6 (the first axial protrusion 6A) in FIG. 3.

Specifically, in each of the fiber-like protrusions 6 (6A to 6D), the amount of protrusions toward the outside in the radial direction increases from both end portions of the predetermined direction toward a center portion and the amount of protrusions is maximum in the center portion of the predetermined direction.

As shown in FIGS. 3 to 7, when viewed from the outside in the radial direction, each of the fiber-like protrusions 6 has a plurality of rib parts 7 which extend in a predetermined direction and are disposed side by side in the width direction and step parts 8 which are disposed between the rib parts 7 adjacent to each other in the width direction or at end portions in the width direction of the rib parts 7 and which extend in a predetermined direction.

In the embodiment, the plurality of rib parts 7 included in the fiber-like protrusions 6 are disposed adjacent to each other in the width direction. Specifically, the rib parts 7 adjacent to each other in the width direction have end portions thereof in the width direction facing each other connected to each other. Furthermore, the plurality of step parts 8 are provided in the fiber-like protrusions 6. Each of the step parts 8 is disposed on a side surface of each of the rib parts 7 which faces the width direction.

At least one of the plurality of rib parts 7 has an amount of protrusions toward the outside in the radial direction which increases from both end portions in the predetermined direction (longitudinal direction) toward the center portion. In the embodiment, the amount of protrusions increases in all of the rib parts 7 included in each of the fiber-like protrusions 6 (6A to 6D) from both end portions toward the center portion in the predetermined direction.

Although not particularly shown, the plurality of rib parts 7 may include rib parts in which the amount of protrusions is constant over the entire length in the predetermined direction. Furthermore, the plurality of rib parts 7 may include rib parts in which the amount of protrusions decreases from both end portions in the predetermined direction toward the center portion.

The plurality of rib parts 7 include outer rib parts 7A which are disposed at outer end portions in the width direction of the fiber-like protrusions 6 and inner rib parts 7B which are disposed further inward in the width direction than the outer rib parts 7A.

The pair of outer rib parts 7A are provided at both end portions on the outer side in the width direction of the fiber-like protrusions 6. The plurality of inner rib parts 7B are provided side by side in the width direction. The inner rib parts 7B adjacent to each other in the width direction have different shapes. The amount of protrusions toward the outside in the radial direction of the plurality of inner rib parts 7B differs from each other.

The inner rib parts 7B have portions having a larger amount of protrusions toward the outside in the radial direction than the outer rib parts 7A. A maximum value of the amounts of protrusions directed toward the outside in the radial direction of the inner rib parts 7B (maximum protrusion dimension) is greater than a maximum value of the amount of protrusions directed toward the outside in the radial direction of the outer rib parts 7A.

For this reason, in each of the fiber-like protrusions 6 (6A to 6D), compared to the amount of protrusions toward the outside in the radial direction (+Z side) at both end portions in the width direction (transverse direction) (the outer rib part 7A), the amount of protrusions toward the outside in the radial direction at the intermediate portion (the inner rib part 7B) located between the both end portions in the width direction is larger.

The plurality of inner rib part 7B include a first inner rib part 7B1 and second inner rib parts 7B2. Of the plurality of inner rib part 7B, the first inner rib part 7B1 has the largest amount of protrusions directed toward the outside in the radial direction in the center portion of the predetermined direction (longitudinal direction). The second inner rib parts 7B2 have a smaller amount of protrusions toward the outside in the radial direction in the center portion of the predetermined direction than the first inner rib part 7B1.

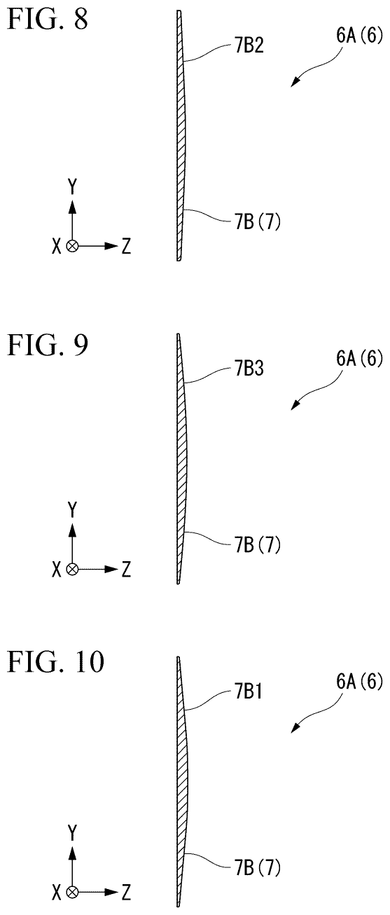

Here, the cross-sectional views shown in FIGS. 8 to 13 represent cross sections taken along lines VIII-VIII to XIII-XIII of the first axial protrusion 6A in FIG. 3. As shown in FIGS. 3, 7, and 8 to 13, the plurality of inner rib parts 7B included in the first axial protrusion 6A include the first inner rib part 7B1, the second inner rib parts 7B2, and third inner rib parts 7B3. The third inner rib parts 7B3 have an amount of protrusions directed toward the outside in the radial direction in the center portion in the predetermined direction which is smaller than that of the first inner rib part 7B1 and larger than that of the second inner rib parts 7B2.

In the first axial protrusion 6A, the first inner rib part 7B1 is located at a center portion in the width direction of the plurality of inner rib parts 7B. Furthermore, the second inner rib parts 7B2 are located at the end portions in the width direction of the plurality of inner rib parts 7B. In addition, the third inner rib parts 7B3 are disposed between the first inner rib part 7B1 and the second inner rib parts 7B2 in the width direction.

The first axial protrusion 6A has one first inner rib part 7B1, two second inner rib parts 7B2, and two third inner rib parts 7B3. That is to say, the first axial protrusion 6A has a total of five inner rib parts 7B.

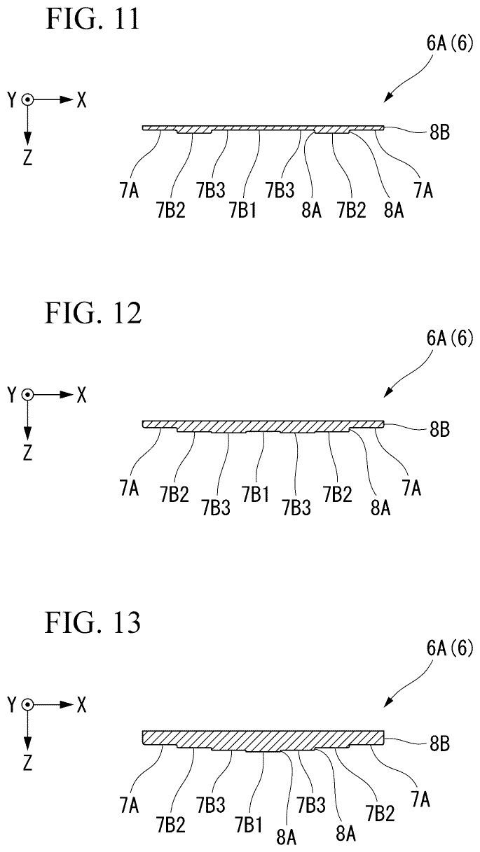

As shown in FIG. 11, at the end portion in the predetermined direction of the first axial protrusion 6A, of the plurality of rib parts 7, the amount of protrusions directed toward the outside in the radial direction (+Z side) of the second inner rib parts 7B2 is the largest. That is to say, the amount of protrusions toward the outside in the radial direction at the end portions in the predetermined direction of the second inner rib parts 7B2 is greater than the amount of protrusions toward the outside in the radial direction at the end portions in the predetermined direction of each of the first inner rib part 7B1, the third inner rib parts 7B3 and the outer rib part 7A.

Also, as shown in FIG. 12, in a predetermined portion located between the end portion and the center portion in the predetermined direction of the first axial protrusion 6A, of the plurality of rib parts 7, the amount of protrusions directed toward the outside in the radial direction of the third inner rib parts 7B3 is the largest.

Moreover, as shown in FIG. 13, in the center portion in the predetermined direction of the first axial protrusion 6A, of the plurality of rib parts 7, the amount of protrusions directed toward the outside in the radial direction of the first inner rib part 7B1 is the largest.

The plurality of rib parts 7 (7A and 7B) included in the first axial protrusion 6A have the same dimensions in the width direction.

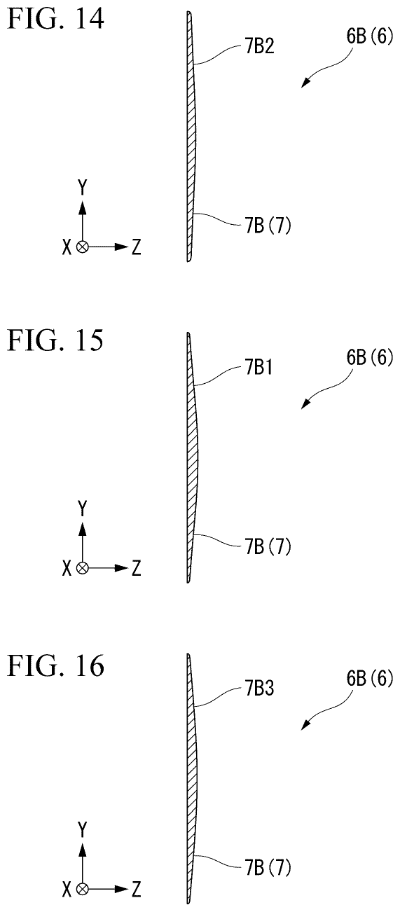

Also, the cross-sectional views shown in FIGS. 14 to 19 represent cross sections taken along lines XIV-XIV to XIX-XIX of the second axial protrusion 6B in FIG. 4. As shown in FIGS. 4 and 14 to 19, the plurality of inner rib parts 7B included in the second axial protrusion 6B include the first inner rib part 7B1, the second inner rib parts 7B2, and the third inner rib parts 7B3. The third inner rib parts 7B3 have an amount of protrusions toward the outside in the radial direction in the center portion in the predetermined direction which is smaller than that of the first inner rib part 7B1 and larger than that of the second inner rib parts 7B2.

In the second axial protrusion 6B, the third inner rib parts 7B3 are disposed in the center portion in the width direction of the plurality of inner rib parts 7B. Furthermore, the second inner rib parts 7B2 are located at the end portions in the width direction of the plurality of inner rib parts 7B. In addition, the first inner rib part 7B1 is disposed between the third inner rib parts 7B3 and the second inner rib parts 7B2 in the width direction.

The second axial protrusion 6B has one third inner rib part 7B3, two second inner rib parts 7B2, and two first inner rib parts 7B1. That is to say, the second axial protrusion 6B has a total of five inner rib parts 7B.

As shown in FIG. 17, at the end portion in the predetermined direction of the second axial protrusion 6B, of the plurality of rib parts 7, the amount of protrusions directed toward the outside in the radial direction (+Z side) of the second inner rib part 7B2 is the largest. That is to say, the amount of protrusions toward the outside in the radial direction at the end portion in the predetermined direction of the second inner rib parts 7B2 is greater than the amount of protrusions toward the outside in the radial direction at the end portions in the predetermined direction of each of the first inner rib parts 7B1, the third inner rib part 7B3 and the outer rib part 7A.

Also, as shown in FIG. 18, in a predetermined portion located between the end portion and the center portion in the predetermined direction of the second axial protrusion 6B, of the plurality of rib parts 7, the amount of protrusions directed toward the outside in the radial direction of the third inner rib part 7B3 is the largest.

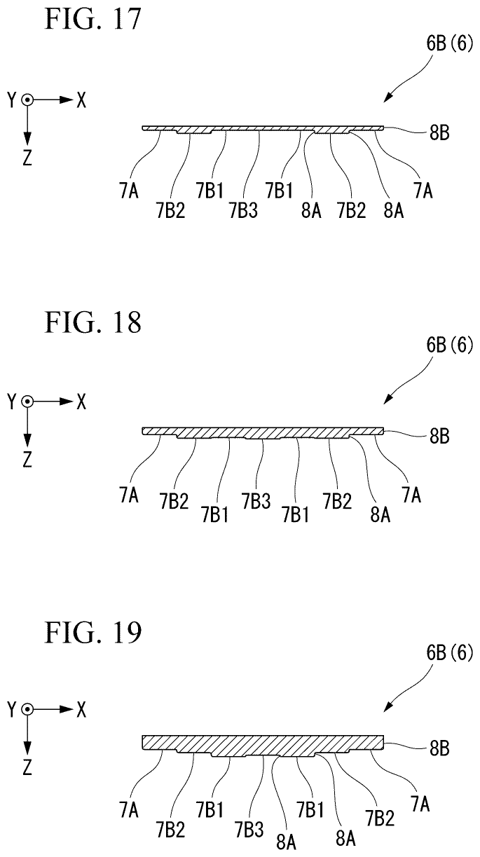

Moreover, as shown in FIG. 19, in the center portion in the predetermined direction of the second axial protrusion 6B, of the plurality of rib parts 7, the amount of protrusions directed toward the outside in the radial direction of the first inner rib parts 7B1 is the largest.

The plurality of rib parts 7 (7A and 7B) included in the second axial protrusion 6B have the same dimensions in the width direction.

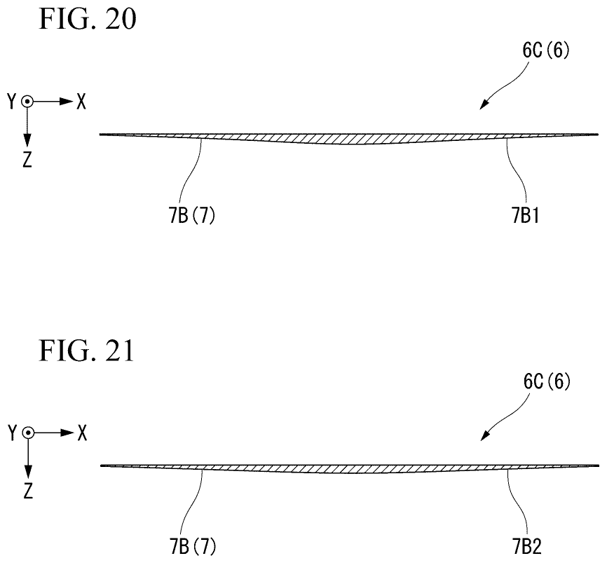

Furthermore, the cross-sectional views shown in FIGS. 20 to 24 represent cross sections taken along lines XX-XX to XXIV-XXIV of the first circumferential protrusion 6C in FIG. 5. As shown in FIGS. 5 and 20 to 24, the plurality of inner rib parts 7B included in the first circumferential protrusion 6C include the first inner rib parts 7B1 and the second inner rib parts 7B2.

The first circumferential protrusion 6C has two first inner rib parts 7B1 and two second inner rib parts 7B2. That is to say, the first circumferential protrusion 6C has a total of four inner rib parts 7B.

In the first circumferential protrusion 6C, the first inner rib parts 7B1 and the second inner rib parts 7B2 (the four inner rib parts 7B) are disposed side by side alternately toward the −Y side (front side) in the width direction in the order of the first inner rib part 7B1, the second inner rib part 7B2, the first inner rib part 7B1, and the second inner rib part 7B2.

Also, the plurality of (two) first inner rib parts 7B1 included in the first circumferential protrusion 6C have different dimensions in the width direction. Furthermore, the plurality of (two) second inner rib parts 7B2 included in the first circumferential protrusion 6C have different dimensions in the width direction.

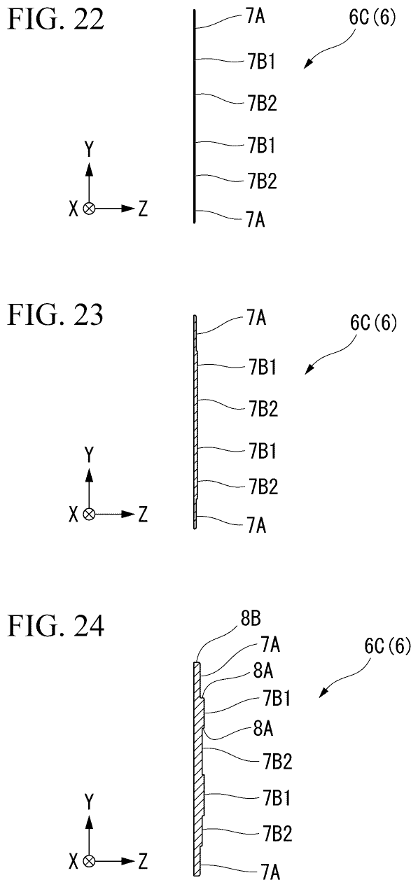

As shown in FIG. 22, at the end portion in the predetermined direction of the first circumferential protrusion 6C, the amount of protrusions directed in each radially outer direction (+Z side) of the plurality of rib parts 7 are the same as each other.

Also, as shown in FIG. 23, in a predetermined portion located between the end portion and the center portion in the predetermined direction of the first circumferential protrusion 6C, the amount of protrusions directed toward the outside in the radial direction of the inner rib part 7B is greater than the amount of protrusions directed toward the outside in the radial direction of the outer rib part 7A. Furthermore, in FIG. 23, the amount of protrusions directed toward the outside in the radial direction of the first inner rib part 7B1 and the amount of protrusions directed toward the outside in the radial direction of the second inner rib part 7B2 are the same as each other.

Moreover, as shown in FIG. 24, in the center portion in the predetermined direction of the first circumferential protrusion 6C, of the plurality of rib parts 7, the amount of protrusions directed toward the outside in the radial direction of the first inner rib part 7B1 is the largest.

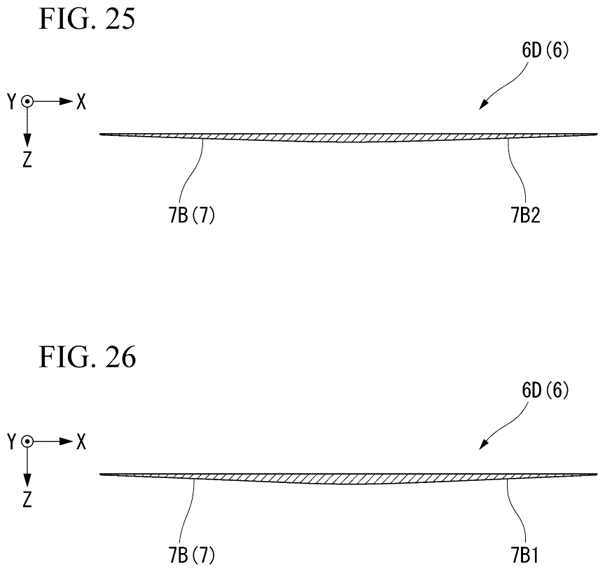

Furthermore, the cross-sectional views shown in FIGS. 25 to 29 represent cross sections taken along lines XXV-XXV to XXIX-XXIX of the second circumferential protrusion 6D in FIG. 6. As shown in FIGS. 6 and 25 to 29, the plurality of inner rib parts 7B included in the second circumferential protrusion 6D include the first inner rib parts 7B1 and the second inner rib parts 7B2.

The second circumferential protrusion 6D has two first inner rib parts 7B1 and two second inner rib parts 7B2. That is to say, the second circumferential protrusion 6D has a total of four inner rib parts 7B.

In the second circumferential protrusion 6D, the first inner rib parts 7B1 and the second inner rib parts 7B2 (the four inner rib parts 7B) are disposed side by side alternately in the width direction toward the −Y side (front side) in the order of the second inner rib part 7B2, the first inner rib part 7B1, the second inner rib part 7B2, and the first inner rib part 7B1.

Also, the plurality of (two) first inner rib parts 7B1 included in the second circumferential protrusion 6D have different dimensions in the width direction. Furthermore, the plurality of (two) second inner rib parts 7B2 included in the second circumferential protrusion 6D have different dimensions in the width direction.

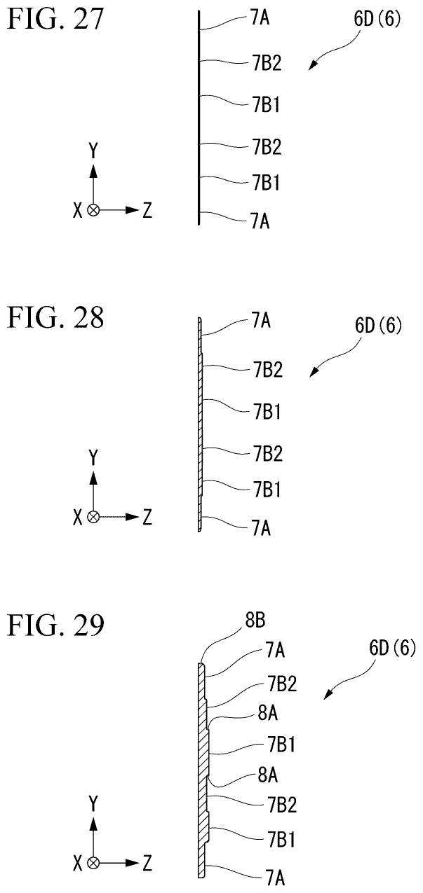

As shown in FIG. 27, at the end portion in the predetermined direction of the second circumferential protrusion 6D, the amount of protrusions toward each radially outer direction (+Z side) of the plurality of rib parts 7 are the same as each other.

Also, as shown in FIG. 28, in a predetermined portion located between the end portion and the center portion in the predetermined direction of the second circumferential protrusion 6D, the amount of protrusions directed toward the outside in the radial direction of the inner rib part 7B is greater than the amount of protrusions directed toward the outside in the radial direction of the outer rib part 7A. Furthermore, in FIG. 28, the amount of protrusions directed toward the outside in the radial direction of the first inner rib part 7B1 and the amount of protrusions directed toward the outside in the radial direction of the second inner rib part 7B2 are the same as each other.

Moreover, as shown in FIG. 29, in the center portion in the predetermined direction of the second circumferential protrusion 6D, of the plurality of rib parts 7, the amount of protrusions directed toward the outside in the radial direction of the first inner rib part 7B1 is the largest.

As shown in FIGS. 3 to 7 and the like, in each of the fiber-like protrusions 6 (6A to 6D), the plurality of step parts 8 include inner step parts 8A which are disposed between the rib parts 7 adjacent to each other in the width direction and extend in a predetermined direction and outer step parts 8B which are disposed at end portions in the width direction of the fiber-like protrusions 6 and extend in a predetermined direction.

The inner step parts 8A are formed in accordance with a difference in the amount of protrusions between the rib parts 7 adjacent to each other in the width direction. Furthermore, the outer step parts 8B are formed on side surfaces directed outward in the width direction of the outer rib parts 7A.

Also, as shown in FIG. 7, the plurality of step parts 8 include at least one of the step parts in which the dimension in the radial direction (Z-axis direction) changes toward the predetermined direction and the step parts in which the dimension in the radial direction is constant over the entire length in the predetermined direction.

As shown in FIG. 2, the parting lines PL are located on the outer circumferential surface of the rear shaft 1b (the axial cylinder 1) and extend in the axial direction.

Reference symbol C shown in FIG. 2 represents a center line C in the circumferential direction of each of the parting lines PL. The dimension in the circumferential direction of the parting line PL is, for example, 1 mm or less. In the embodiment, the dimension in the circumferential direction of the parting line PL is 0.5 mm or less, specifically, about 0.3 to 0.4 mm.

A plurality of parting lines PL are provided at intervals from each other in the circumferential direction on the outer circumferential surface of the rear shaft 1b. In the embodiment, the pair of parting lines PL are provided at equal pitches in the circumferential direction. That is to say, the pair of parting lines PL are disposed at positions which are rotationally symmetrical to each other by 180°with respect to the center axis O of the axial cylinder 1 as a center thereof.

Each of the parting lines PL is formed along the opposing surfaces (parting surfaces) of a pair of molds (not shown) for injection molding the rear shaft 1b. Specifically, the parting line PL is formed by transferring the shape of a non-laser processed portion of the inner surface of the mold for molding the rear shaft 1b which is disposed at the end portion in the circumferential direction and extends in the axial direction, to the outer circumferential surface of the rear shaft 1b during injection molding.

In the embodiment, the parting line PL formed on the outer circumferential surface of the rear shaft 1b is a shiny glossy surface because the non-laser processed portion is transferred to the parting line PL.

In the writing tool 10 of the embodiment described above, the plurality of fiber-like protrusions 6 are provided on the outer circumferential surface of the axial cylinder 1. Each of the fiber-like protrusions 6 has the plurality of rib parts 7 which extend in the predetermined direction and the step parts 8 which are disposed between the rib parts 7 adjacent to each other in the width direction or at an end portions in the width direction of the rib parts 7. The plurality of fiber-like protrusions 6 configured in this way can provide, to a user or the like, a sensation as if the outer circumferential surface of the axial cylinder 1 were formed of an actual fabric or cloth woven with thread or a tatami mat or the like woven with rush or the like (hereinafter referred to as a fabric or the like).

Specifically, the plurality of rib parts 7 and the step parts 8 allow the shading of the fiber-like protrusions 6 to approximate the shading of threads, rushes, or the like that are an element of a fabric or the like. For this reason, it is possible to provide, to a user or the like of the writing tool 10, a visual sensation as if the outer circumferential surface of the axial cylinder 1 were formed of a fabric or the like.

Also, when a user or the like of the writing tool 10 touches the fiber-like protrusions 6 with his or her fingertips or the like, the plurality of rib parts 7 and the step part 8 can provide a tactile sensation as if the user were touching the surface of an actual fabric. Specifically, it is possible to obtain a sensation having directionality, for example, as if the fiber of the surface of a thread, a rush, or the like extended in the predetermined direction.

Also, although not particularly shown, when the writing tool 10 is used, the outer circumferential surface of the axial cylinder 1 comes into contact with the “inter-finger space” between the base of the index finger and the base of the thumb of the user's hand. In the writing tool 10, the fiber-like protrusions 6 are provided so that an excellent touch sensation of the axial cylinder 1 between the fingers can also be provided.

From the above, according to the embodiment, it is possible to provide a sensation as if the outer circumferential surface of the axial cylinder 1 were formed of an actual fabric or the like, it is possible to improve the design by providing an excellent exterior form, an excellent touch sensation is provided, and the usability is improved.

Also, in the embodiment, the fiber-like protrusions 6 have a larger amount of protrusions toward the outside in the radial direction in an intermediate portion located between both end portions in a predetermined direction than in both end portions.

Furthermore, the fiber-like protrusions 6 have a larger amount of protrusions toward the outside in the radial direction in an intermediate portion located between both end portions in the width direction than in both end portions.

In this case, the shape of the fiber-like protrusions 6 can be provided to more closely resemble the shape of the exposed parts of threads, rushes, or the like which constitute an actual fabric or the like. This makes it possible to more stably impart visual and tactile sensations as if the outer circumferential surface of the axial cylinder 1 were formed of an actual fabric or the like. The effects of improving the design and the usability become more pronounced.

Moreover, in the embodiment, the plurality of rib parts 7 of the fiber-like protrusions 6 include the outer rib part 7A and the inner rib part 7B and the inner rib part 7B has a portion having a larger amount of protrusions toward the outside in the radial direction than the outer rib part 7A.

In this case, the fiber-like protrusions 6 have the inner rib part 7B located on the inside in the width direction protruding further in the outside in the radial direction than the outer rib part 7A located on the outer end portion in the width direction. Thus, the shape of the fiber-like protrusions 6 can be provided to more closely resemble the shape of exposed parts of threads, rushes, or the like which constitute an actual fabric or the like. Therefore, the above-described effects become more pronounced.

Also, in the embodiment, the fiber-like protrusions 6 have a plurality of inner rib parts 7B aligned in the width direction and the amounts of protrusions (that is, height dimension) in the outside in the radial direction of the inner rib parts 7B are different from each other. Thus, the shape of the fiber-like protrusions 6 can be provided to more closely resemble the shape of exposed parts of threads, rushes, or the like which constitute an actual fabric or the like. Therefore, the above-described effects become more pronounced.

Moreover, in the embodiment, the plurality of inner rib parts 7B include the first inner rib part 7B1 which has the largest amount of protrusions toward the outside in the radial direction in a center portion in a predetermined direction and the second inner rib part 7B2 which has the smaller amount of protrusions toward the outside in the radial direction in the center portion in the predetermined direction than that of the first inner rib part 7B1. Furthermore, the amount of protrusions toward the outside in the radial direction at the end portion in the predetermined direction of the second inner rib part 7B2 is greater than the amount of protrusions toward the outside in the radial direction at the end portion in the predetermined direction of the first inner rib part 7B1.

In this case, of the plurality of inner rib parts 7B included in the fiber-like protrusions 6, the inclination and the shape of the first inner rib part 7B1 and the second inner rib part 7B2 are different from each other. Thus, the shape of the fiber-like protrusions 6 can be provided to more closely resemble the shape of exposed parts of threads, rushes, or the like which constitute an actual fabric or the like. Therefore, the above-described effects become more pronounced.

Also, in the embodiment, the plurality of fiber-like protrusions 6 include the axial protrusions 6A and 6B which extend in the axial direction and the circumferential protrusions 6C and 6D which extend in the circumferential direction and the axial protrusions 6A and 6B and the circumferential protrusions 6C and 6D are arranged alternately in at least one of the axial direction and the circumferential direction.

In this case, for example, the axial protrusions 6A and 6B act (function) as warp threads and the circumferential protrusions 6C and 6D act (function) as weft threads. In addition, it is possible to impart a visual and tactile sensation to the axial cylinder 1 as if they were alternately interwoven with each other. This more effectively imparts the sensation as if the outer circumferential surface of the axial cylinder 1 were formed of an actual fabric or the like.

Also, in the embodiment, the axial protrusions 6A and 6B have a larger amount of protrusions toward the outside in the radial direction than the circumferential protrusions 6C and 6D.

In this case, on the outer circumferential surface of the axial cylinder 1, the warp threads (axial protrusions 6A and 6B) can be more visually and tactilely emphasized than the weft threads (circumferential protrusions 6C and 6D). For this reason, it is possible to further increase the degree of freedom in design and further improve a touch sensation.

Also, in the embodiment, the plurality of fiber-like protrusions 6 include a plurality of types of axial protrusions 6A and 6B having mutually different shapes and a plurality of types of circumferential protrusions 6C and 6D having mutually different shapes.

In this case, it is possible to more effectively impart a visual and tactile sensation as if the outer circumferential surface of the axial cylinder 1 were formed of an actual fabric or the like.

Moreover, in the embodiment, the fiber-like protrusions 6 have a surface having a textured surface.

As in the above constitution, if the surfaces of the fiber-like protrusions 6 have a textured surface, it is possible to impart a subtle matte shading and a smooth and comfortable feel to the fiber-like protrusions 6. For this reason, it is possible to further improve the design and to further improve the usability.

Also, in the embodiment, the plurality of fiber-like protrusions 6 include the axial protrusions 6A and 6B in which they and the clip 4 overlap when viewed in the radial direction and extend in the axial direction.

In this case, when the clip 4 is used to hang the writing tool 10 on a pocket or the like of a user's clothing or the like and be held or when the writing tool 10 is removed from a pocket or the like, the material of the pocket or the like is made to slide easily between the clip 4 and the axial protrusions 6A and 6B and the material is stably clamped. The Writing Tool 10 is easily hung on a pocket or the like and is also easily removed, making it comfortable to use.

Also, in the embodiment, the fiber-like protrusions 6 are disposed on a portion of the outer circumferential surface of the axial cylinder 1 other than a portion covered by the grip part 3.

In this case, the grip part 3 provides an anti-slip function during writing or the like and the fiber-like protrusions 6 are not blocked by the grip part 3. For this reason, the above-described effects can be obtained more stably.

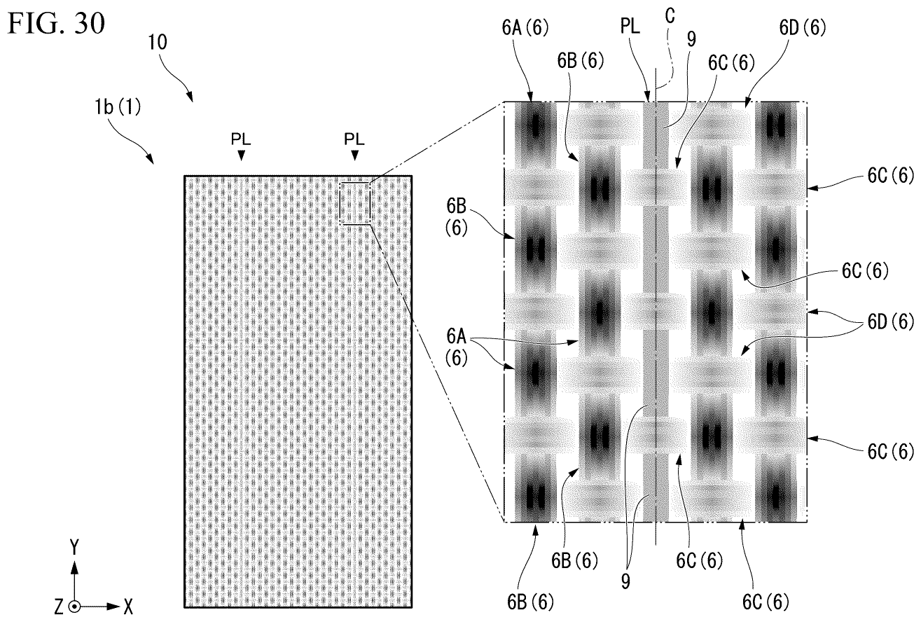

Here, a modified example of the first embodiment will be explained with reference to FIG. 30. In the illustration of the modified example, the same constituent elements as those in the above-described embodiment are denoted by the same reference symbols and the following mainly describes the differences.

FIG. 30 is a plan view showing an outer circumferential surface of an axial cylinder 1 of a writing tool 10 in the modified example of the first embodiment in a developed form and an enlarged view showing a part of the plan view in an enlarged form. As shown in FIG. 30, in the modified example, at least one of a plurality of circumferential protrusions 6C and 6D is located on a parting line PL. In the illustrated example, of the plurality of circumferential protrusions 6C and 6D, at least the first circumferential protrusion 6C is disposed to straddle the parting line PL in the circumferential direction (X-axis direction) and extends intersecting the parting line PL. Furthermore, the plurality of circumferential protrusions 6C and 6D located on the parting line PL are provided side by side in the axial direction (Y-axis direction).

Also, the parting line PL has textured surfaces 9 which extend in the axial direction. Each of the textured surfaces 9 is a frosted-glass-shaped (cloudy-glass-shaped) or satin-finished surface and has a surface roughness of a predetermined value or more. The textured surface 9 may be rephrased as, for example, a matte (frosted) processed surface or the like. The textured surface 9 is formed by transferring a laser processed portion of the inner surface of the mold when the rear shaft 1b is subjected to injection molding. In the illustrated example, the plurality of textured surfaces 9 are provided side by side in the axial direction.

The circumferential protrusions 6C and 6D which intersect the parting line PL and the textured surface 9 are arranged alternately in the axial direction.

Unlike the constitution of the modified example above, for example, in the case where the fiber-like protrusions 6 (axial protrusions 6A and 6B) extending in the axial direction are arranged on the parting line PL, when a pair of molds are separated from each other after injection molding, the axial protrusions 6A and 6B on the parting line PL may rub against the molds, causing them to break off or become burrs.

On the other hand, as in the constitution of the modified example above, when the circumferential protrusions 6C and 6D extending in the circumferential direction are located on the parting line PL, a pair of molds are spaced apart from each other in a direction in which the circumferential protrusions 6C and 6D extend. Thus, this makes it possible to suppress defects such as chipping and burrs as described above. For this reason, while the parting line PL necessary for manufacturing is provided on the outer circumferential surface of the axial cylinder 1, it is possible to prevent the pattern of a fabric or the like from being interrupted or looking unnatural on the parting line PL, thereby making it possible to further improve the design.

Also, since the parting line PL has the textured surface 9, while the parting line PL necessary for manufacturing can be provided on the outer circumferential surface of the axial cylinder 1, the parting line PL can be made inconspicuous. For this reason, it becomes possible to further improve the design.

### Second Embodiment

A writing tool 20 in a second embodiment of the present invention will be described below with reference to FIGS. 1 and 31 to 37. In the embodiment, the same constituent elements as those in the above-described embodiment may be denoted by the same names or reference symbols and description thereof may be omitted in some cases. Furthermore, unless otherwise specified, the definitions of directions are the same as those in the above-described embodiment.

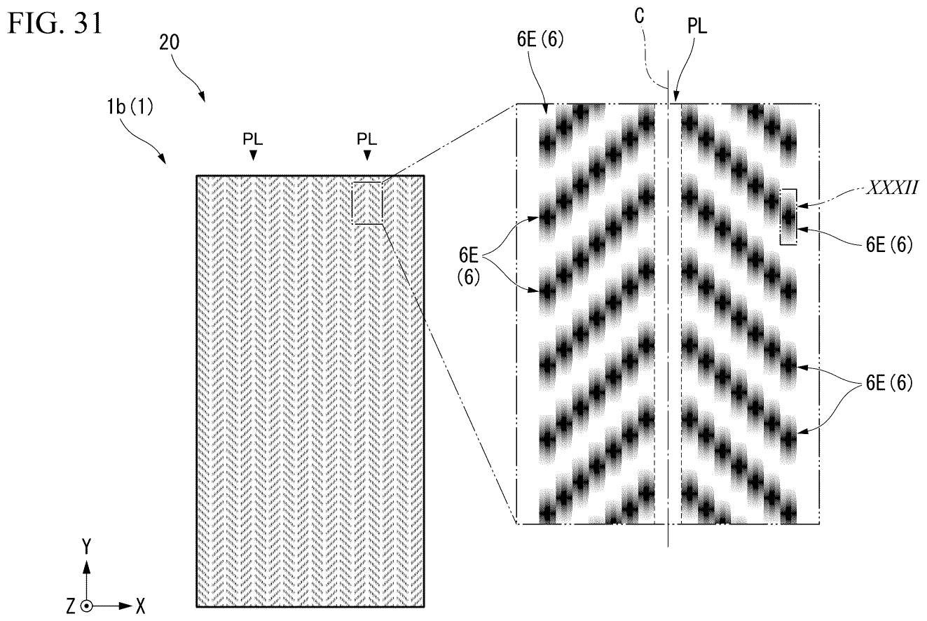

FIG. 31 is a plan view showing an outer circumferential surface of an axial cylinder 1 of the writing tool 20 in the second embodiment in a developed form and an enlarged view showing a part of the plan view in an enlarged form. As shown in FIG. 31, the writing tool 20 in the embodiment is different from the writing tool 10 described in the above embodiment in the shape, the disposition, and the like of the fiber-like protrusions 6.

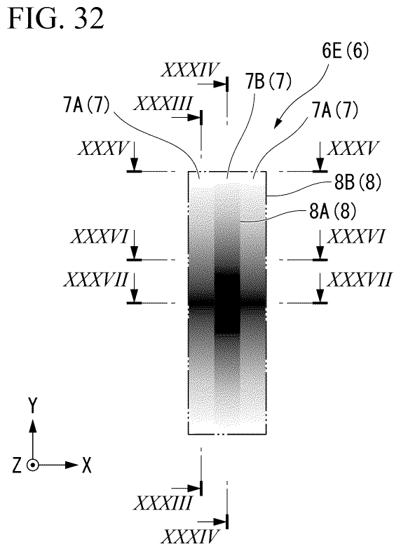

The monochrome image shown in each drawing of FIGS. 31 and 32 shows, using shades of black and white, a laser intensity (laser output) when subjecting an inner surface of a mold for forming a rear shaft 1b to laser processing. Furthermore, the monochrome image shown in each drawing of FIGS. 31 and 32 show, using shades of black and white, amounts of protrusions of fiber-like protrusions 6 which protrude in the outside in the radial direction from an outer circumferential surface (base surface) of the rear shaft 1b.

As shown in FIG. 31, in the embodiment, the plurality of fiber-like protrusions 6 provided on the outer circumferential surface of the rear shaft 1b include a plurality of axial protrusions 6E extending in the axial direction. The plurality of rows of axial protrusions 6E disposed at intervals in the axial direction are provided side by side in the circumferential direction. Of the pair of rows of axial protrusions 6E adjacent to each other in the circumferential direction, the positions of the axial directions of the axial protrusions 6E in one row and the axial protrusions 6E in the other row are shifted from each other.

Also, in the embodiment, it is also said that the plurality of axial protrusions 6E form inclined rows extending in the axial direction as they are directed in the circumferential direction.

Specifically, in the example shown in FIG. 31, the plurality of axial protrusions 6E disposed on one side in the circumferential direction (+X side) of the parting line PL form inclined rows extending toward the front side (−Y side) as they are directed toward one side in the circumferential direction. The plurality of rows of inclined rows are provided side by side in the axial direction.

Also, the plurality of axial protrusions 6E disposed on the other side in the circumferential direction (−X side) of the parting line PL form the inclined rows which extend toward the front side (−Y side) as they are directed toward the other side in the circumferential direction. The plurality of rows of inclined rows are provided in the axial direction.

As shown in FIG. 32, also in the embodiment, the fiber-like protrusions 6 (axial protrusions 6E) have a plurality of rib parts 7 which extend in a predetermined direction (Y-axis direction) when viewed from the outside in the radial direction (+Z side) and are disposed side by side in the width direction (X-axis direction) and step parts 8 which are disposed between the rib parts 7 adjacent to each other in the width direction or at the end portions in the width direction of the rib parts 7 and extend in a predetermined direction.

The plurality of rib parts 7 include a pair of outer rib parts 7A which are disposed at both end portions of the outer sides in the width direction of the fiber-like protrusions 6 (6E) and one inner rib part 7B which is disposed further inward in the width direction than the outer rib parts 7A. That is to say, the axial protrusions 6E have a total of three rib parts 7.

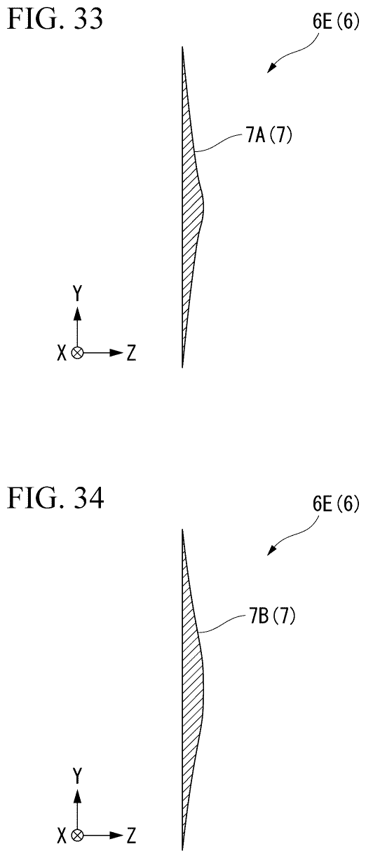

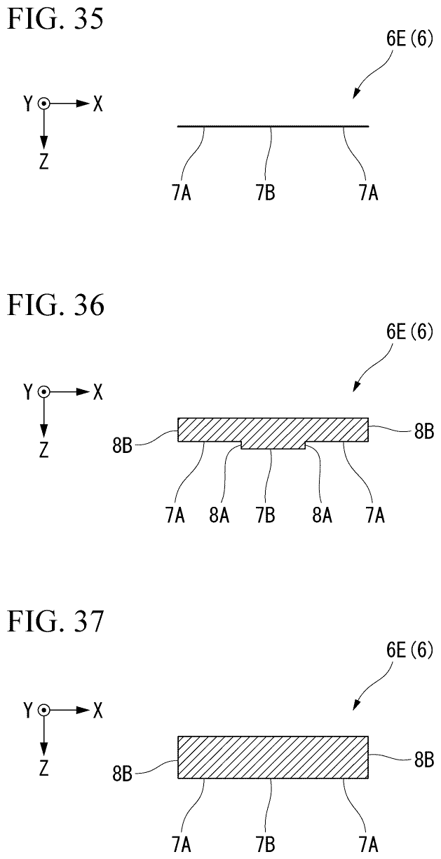

Cross-sectional views shown in FIGS. 33 to 37 represent cross sections taken along lines XXXIII-XXXIII to XXXVII-XXXVII of the axial protrusions 6E in FIG. 32. As shown in FIG. 35, at the end portions in the predetermined direction of the axial protrusions 6E, the amounts of protrusions directed toward the outside in the radial directions (+Z side) of the plurality of rib parts 7 are the same as each other.

Also, as shown in FIG. 36, in a predetermined portion located between the end portion and the center portion in the predetermined direction of the axial protrusions 6E, the amount of protrusions directed toward the outside in the radial direction of the inner rib part 7B is greater than the amount of protrusions directed toward the outside in the radial direction of the outer rib parts 7A. That is to say, also in the embodiment, the inner rib part 7B has a portion having a larger amount of protrusions toward the outside in the radial direction than the outer rib parts 7A.

Also, as shown in FIG. 37, in the center portion in the predetermined direction of the axial protrusions 6E, the amounts of protrusions toward the outside in the radial directions of the plurality of rib parts 7 are the same as each other.

The writing tool 20 of the embodiment described above also provides the same effects as those of the above-described embodiment.

The present invention is not limited to the above-described embodiment, and for example, as will be described below, the constitution can be modified without departing from the spirit of the present invention.

Although an example in which the fiber-like protrusions 6 (6A to 6E) each extend in a predetermined direction when viewed from the outside in the radial direction has been provided in the above-described first and second embodiments, the present invention is not limited thereto. Specifically, in the present invention, the rib parts 7 and the step parts 8 included in the fiber-like protrusions 6 may each extend in the predetermined direction. For this reason, although not particularly shown, the fiber-like protrusions 6 may have the same dimension in the predetermined direction and the same dimension in the width direction when viewed from the outside in the radial direction. Alternatively, the fiber-like protrusions 6 may have a dimension in the width direction greater than a dimension in the predetermined direction when viewed from the outside in the radial direction.

Also, although a knock-type ballpoint pen is provided as an example of the writing tools 10 and 20 in the above-described first and second embodiments, the present invention is not limited thereto. The writing tools 10 and 20 may be ballpoint pens other than knock-type ballpoint pens or may be pens other than ballpoint pens.

The present invention may combine the various constitutions described in the above-described embodiments, modified examples, and the like without departing from the spirit of the present invention, and addition, omission, substitution, and other modifications of constitutions are possible. Furthermore, the present invention is not limited to the above-described embodiment, but is limited only by the claims.

### INDUSTRIAL APPLICABILITY

According to a writing tool of the present invention, it is possible to provide a sensation as if the outer circumferential surface of the axial cylinder were formed of a fabric or the like, it is possible to improve the design by providing an excellent exterior form, an excellent touch sensation is provided, and the usability is improved.

### REFERENCE SIGNS LIST

1 Axial cylinder
2 Writing member
3 Grip part
4 Clip
6 (6A to 6E) Fiber-like protrusion
6A, 6B, 6E Axial protrusion
6C, 6D Circumferential protrusion
7 Rib part
7A Outer rib part
7B Inner rib part
8 Step part
9 Textured surface of parting line
10, 20 Writing tool
7B1 First inner rib part
7B2 Second inner rib part
O Center axis
PL Parting line

1. A writing tool comprising:
an axial cylinder which extends in an axial direction along a center axis; and
a writing member which is disposed inside the axial cylinder,
wherein the axial cylinder has fiber-like protrusions which protrude toward an outside in a radial direction from an outer circumferential surface of the axial cylinder,
the plurality of fiber-like protrusions are provided side by side on the outer circumferential surface, and
each of the fiber-like protrusions has
a plurality of rib parts which extend in a predetermined direction when viewed from the outside in the radial direction and are disposed side by side in a width direction which is orthogonal to the predetermined direction, and
step parts which are disposed between the rib parts adjacent to each other in the width direction or at end portions in the width direction of the rib parts and extend in the predetermined direction.

2. The writing tool according to claim 1, wherein the fiber-like protrusion has a larger amount of protrusion toward the outside in the radial direction in an intermediate portion located between both the end portions in the predetermined direction than in both the end portions.

3. The writing tool according to claim 1, wherein the fiber-like protrusion has a larger amount of protrusion toward the outside in the radial direction in an intermediate portion located between both the end portions in the width direction than in both the end portions.

4. The writing tool according to claim 1, wherein the plurality of rib parts each include
outer rib parts which are disposed at outer end portions in the width direction of the fiber-like protrusions, and
inner rib parts which are disposed further inward in the width direction than the outer rib parts, and
the inner rib parts each have a portion having a larger amount of protrusions toward the outside in the radial direction than the outer rib parts.

5. The writing tool according to claim 4, wherein the plurality of inner rib parts are provided side by side in the width direction.

6. The writing tool according to claim 5, wherein the plurality of inner rib parts are different from each other in an amount of protrusions toward the outside in the radial direction.

7. The writing tool according to claim 5, wherein the plurality of inner rib parts each include
of the plurality of inner rib parts, first inner rib parts which have a largest amount of protrusions toward the outside in the radial direction in a center portion in the predetermined direction, and
second inner rib parts which have a smaller amount of protrusions toward the outside in the radial direction in the center portion in the predetermined direction than the first inner rib parts, and
an amount of protrusions toward the outside in the radial direction at the end portions in the predetermined direction of the second inner rib parts is greater than an amount of protrusions toward the outside in the radial direction at the end portions in the predetermined direction of the first inner rib parts.

8. The writing tool according to claim 1, wherein the plurality of fiber-like protrusions each include
an axial protrusion which extends in an axial direction, and
a circumferential protrusion which extends in a circumferential direction, and
the axial protrusion and the circumferential protrusion are arranged alternately in at least one of the axial direction and the circumferential direction.

9. The writing tool according to claim 1, wherein the plurality of fiber-like protrusions each include
an axial protrusion which extends in an axial direction, and
a circumferential protrusion which extends in a circumferential direction, and
the axial protrusion has a larger amount of protrusions toward the outside in the radial direction than the circumferential protrusion.

10. The writing tool according to claim wherein the plurality of fiber-like protrusions each include
a plurality of types of axial protrusions which extend in an axial direction and have different shapes, and
a plurality of types of circumferential protrusions which extend in a circumferential direction and have different shapes.

11. The writing tool according to claim wherein the fiber-like protrusions have textured surfaces on surfaces thereof.

12. The writing tool according to claim wherein the axial cylinder has a parting line which is disposed on an outer circumferential surface of the axial cylinder and extends in an axial direction,
the plurality of fiber-like protrusions include a plurality of circumferential protrusions which extend in a circumferential direction, and
at least one of the plurality of circumferential protrusions is located on the parting line.

13. The writing tool according to claim 12, wherein the parting line has a textured surface which extends in an axial direction.

14. The writing tool according to claim further comprising:
a clip which is disposed to face the axial cylinder from the outside in the radial direction and extends in an axial direction,
wherein the plurality of fiber-like protrusions include an axial protrusion in which the axial protrusion and the clip overlap when viewed from a radial direction and which extends in an axial direction.

15. The writing tool according to claim further comprising:
a grip part which fits onto an outer circumferential surface of the axial cylinder,
wherein the fiber-like protrusions are disposed on a portion of the outer circumferential surface of the axial cylinder other than a portion covered by the grip part.
